(19) United States
(12) Patent Application Publication
(10) Pub. No.: US 2012/0188440 A1
(43) Pub. Date: Jul. 26, 2012

(54) CAMERA DEVICE, MOBILE TERMINAL AND AE CONTROLLING METHOD

(75) Inventor: Minoru TAKEUCHI, Osaka (JP)

(73) Assignee: KYOCERA CORPORATION, Kyoto (JP)

(21) Appl. No.: 13/354,232

(22) Filed: Jan. 19, 2012

(30) Foreign Application Priority Data
Jan. 21, 2011 (JP) 2011-010423

(51) Int. Cl. H04N 5/235

(52) U.S. Cl. 348/362; 348/E05.037

(57) ABSTRACT

A mobile phone apparatus is provided with a camera module 36 having an image sensor and an exposure evaluating circuit. When a camera function is turned on, an image sensor outputs image data, and the exposure evaluating circuit performs AE controlling processing based on an exposure time in correspondence with a luminance evaluated value of the image data. Also, in a case that the ambient is dark, and thus, illumination of an object is low, that is, in a case that the luminance evaluated value of the image data is less than a predetermined value, an LED 40 emits light as a flash in imaging. At this time, the AE controlling processing is suspended to thereby change the current exposure time into a predicted exposure time. Then, the AE controlling processing is started regarding the changed predicted exposure time as a starting point of the control.

### CROSS REFERENCE OF RELATED APPLICATION

The disclosure of Japanese Patent Application No. 2011-10423 is incorporated herein by reference.

### BACKGROUND OF THE INVENTION

1. Field of the Invention

The present invention relates to a camera device, a mobile terminal and an AE controlling method. More specifically, the present invention relates to a camera device, a mobile terminal and a AE controlling method that adjust luminance of images by an automatic exposure (AE) control.

2. Description of the Related Art

One example of a mobile terminal that adjusts luminance of images by an automatic exposure control is disclosed in Japanese Patent Application Laying-Open No. 2004-328068 [H04N 5/238, G03B 7/16, G03B 15/04, G03B 15/05, H04N 5/235] laid-open on Nov. 18, 2004. An imaging device of the related art performs a preliminary light emission and a main light emission in imaging. An exposure value when a light-emission is not performed is stored, and whereby, an exposure value during the main light emission is accurately predicted from the light emission value when the preliminary light emission is performed and the exposure value when the light-emission is not performed.

However, in the imaging device, in a case that a change in brightness between times when the light-emission is not performed and when the preliminary light emission is performed is great, an exposure compensation control is performed so as not to exceed the amount of the change in brightness, and therefore, it takes a time for an exposure compensation control. That is, it takes a time before the exposure value at a time of the preliminary light emission is obtained, impairing usability by a user in imaging.

### SUMMARY OF THE INVENTION

Therefore, it is a primary object of the present invention to provide a novel camera device, mobile terminal and AE controlling method.

Another object of the present invention is to provide a camera device, mobile terminal and AE controlling method capable of improving usability in imaging.

The present invention employs following features in order to solve the above-described problem. It should be noted that reference numerals and the supplements inside the parentheses show one example of a corresponding relationship with the embodiments described later for easy understanding of the present invention, and do not limit the present invention.

A first embodiment is a camera device having an image sensor for outputting image data and an AE controller for performing an AE control based on an exposure time in correspondence with a luminance value of the image data output from the image sensor, comprising: a light-emitter which emits light when the luminance value is less than a predetermined value; and a storager which stores a predicted exposure time indicating a predetermined exposure time; wherein the AE controller performs an AE control based on the predicted exposure time in a case that the light-emitter emits light.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustrative view showing an electric configuration of a mobile phone apparatus of one embodiment of the present invention.

FIG. 2 is an illustrative view showing an electric configuration of a camera module shown in FIG. 1.

FIG. 3 is an illustrative view showing one example of a process of AE controlling processing by an exposure evaluating circuit shown in FIG. 2.

FIG. 4 is an illustrative view showing one example of a memory map of a RAM shown in FIG. 1.

FIG. 5 is a flowchart showing one example of camera function processing by a processor shown in FIG. 1.

### DETAILED DESCRIPTION OF THE PREFERRED EMBODIMENTS

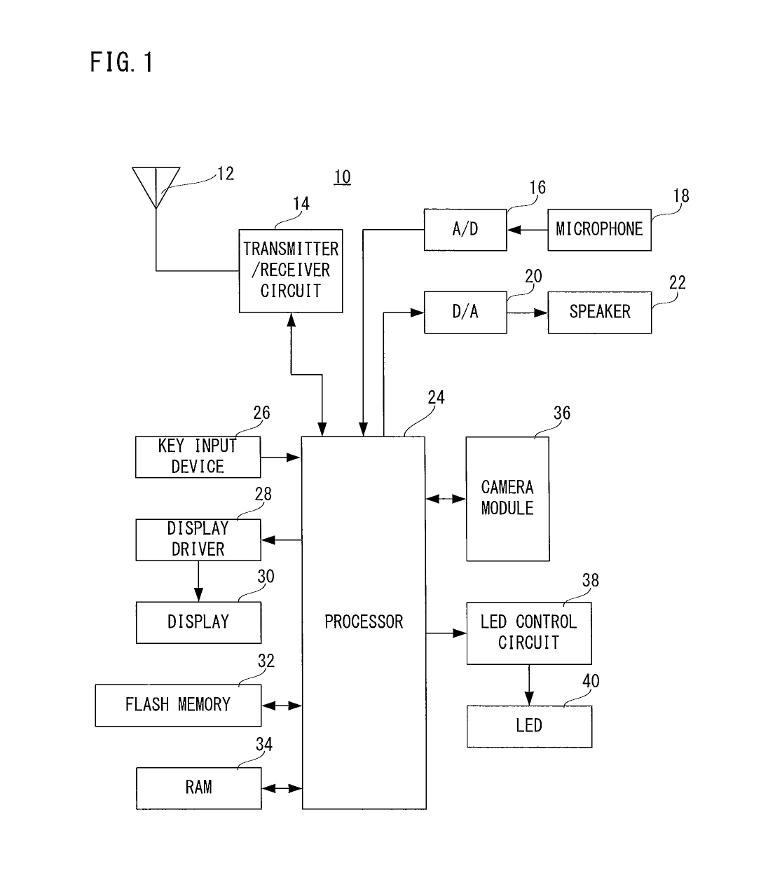

Referring to FIG. 1, a mobile phone apparatus 10 of this embodiment is one kind of mobile communication terminals, and includes a processor 24 which is called a computer or a CPU. Furthermore, the processor 24 is connected with a transmitter/receiver circuit 14, an A/D converter 16, a D/A converter 20, a key input device 26, a display driver 28, a flash memory 32, a RAM 34, a camera module 36, and an LED control circuit 38. The transmitter/receiver circuit 14 is connected with an antenna 12, the A/D converter 16 is connected with a microphone 18, and the D/A converter 20 is connected with a speaker 22. Furthermore, the display driver 28 is connected with a display 30. In addition, the LED control circuit 38 is connected with an LED 40. Also, the mobile phone apparatus 10 is provided with a camera module 36, and thus may be called a camera device.

The processor 24 entirely controls the mobile phone apparatus 10. The RAM 34 is also called a storager, and utilized as a work area (including depiction area) or a buffer area of the processor 24. In the flash memory 32, content data of characters, images, voices, sounds, and video images for the mobile phone apparatus 10 are recorded.

The A/D converter 16 converts an analog voice signal relative to a voice or a sound input through the microphone 18 connected to the A/D converter 16 into a digital voice signal. The D/A converter 20 converts (decodes) a digital voice signal into an analog voice signal, and applies the converted signal to the speaker 22 via an amplifier not shown. Accordingly, a voice or a sound corresponding to the analog voice signal is output from the speaker 22. Here, the processor 24 controls an amplification factor of the amplifier to thereby adjust the volume of the voice output from the speaker 22.

The key input device 26 is called an operator, and is provided with a shutter key for photographing, a cursor key, an off-hook key and an on-hook key. Then, key information (key data) operated by a user is input to the processor 24. Also, when any key included in the key input device 26 is operated, a clicking sound is produced. Accordingly, the user can gain an operational feeling with respect to the key operation by listening to the clicking sound.

The display driver 28 controls display of the display 30 connected to the display driver 28 under the instruction of the processor 24. Also, the display driver 28 includes a video memory (not illustrated) for temporarily storing the image data to be displayed.

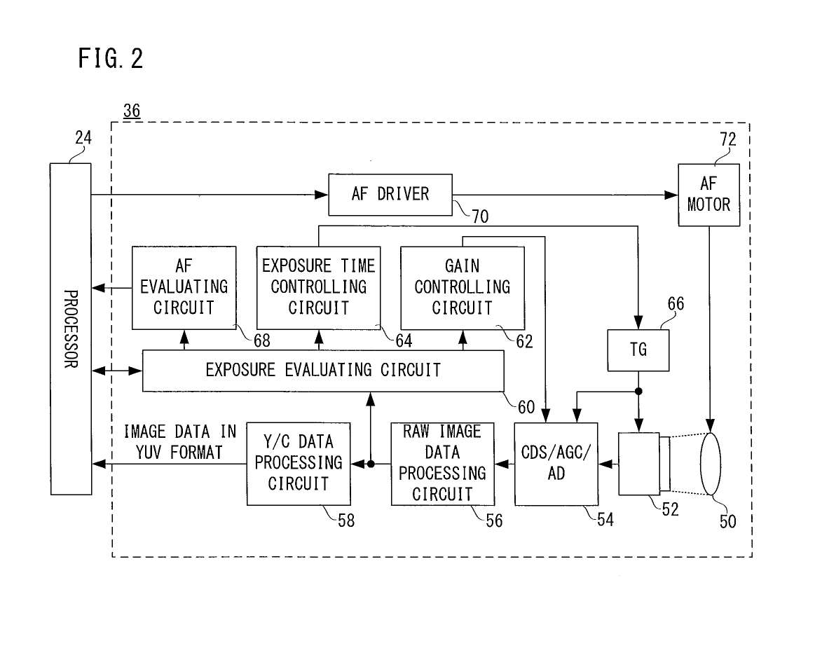

The camera module 36 is made up of components and circuitry that are required to execute a camera function. It should be noted that the camera module 36 will be described in detail by using FIG. 2, and therefore, a description is omitted here.

The LED control circuit 38 controls light-emission of the LED 40 connected thereto under the instruction of the processor 24. Furthermore, in a case that the camera function is turned on, the LED 40 may emit light as a flash. Thus, the LED 40 may be called a light-emitter. Here, the LED 40 may emit light for notifying the presence of an incoming call. Also, an LED for key backlight and an LED for display backlight although not shown are connected to the LED control circuit 38.

The transmitter/receiver circuit 14 is a circuit for making wireless communications according to a CDMA system. For example, when an outgoing call is instructed by the user using the input device 26, the transmitter/receiver circuit 14 executes outgoing call processing under the instruction of the processor 24 and outputs an outgoing call signal via the antenna 12. The outgoing call signal is sent to a phone of a communication partner through base stations and communication networks (not illustrated). Then, when incoming call processing is performed by the phone of the communication partner, a communication allowable state is established, and the processor 24 executes speech communication processing.

Normal speech communication processing is explained in detail. A modulated voice signal transmitted from the phone of the communication partner is received by the antenna 12. The received modulated audio signal is subjected to demodulation processing and decode processing by the transmitter/receiver circuit 14. Then, the received voice signal acquired through such processing is converted into an analog voice signal by the D/A converter 20, and then output from the speaker 22. On the other hand, a voice signal to be transmitted that is captured through the microphone 18 is converted into a digital voice signal by the A/D converter 16, and then applied to the processor 24. The voice signal to be transmitted which has been converted into a digital voice signal is subjected to encoding processing and modulation processing by the transmitter/receiver circuit 14 under the control of the processor 24 and is output via the antenna 12. Thus, the modulated audio signal is sent to the phone of the communication partner via base stations and communication networks.

Furthermore, when an outgoing call signal from the communication partner is received by the antenna 12, the transmitter/receiver circuit 14 notifies an incoming call to the processor 24. In response thereto, the processor 24 controls the display driver 28 to display calling source information (phone number, etc.) described in the incoming call notification on the display 30. Furthermore, at almost the same time, the processor 24 outputs a ringing tone (ringing melody, ringing voice) from a speaker not shown.

Then, when the user performs an answer operation using the off-hook key, the transmitter/receiver circuit 14 executes incoming call processing under the instruction of the processor 24. Then, when a communication allowable state is established, the processor 24 executes the above-described normal speech communication processing.

Furthermore, when a speech communication end operation is performed by the on-hook key after a shift to the speech communication allowable state, the processor 24 sends a speech communication end signal to the communication partner by controlling the transmitter/receiver circuit 14. After sending the speech communication end signal, the processor 24 ends the speech communication processing. Furthermore, in a case that a speech communication end signal from the communication partner is received as well, the processor 24 ends the speech communication processing. In addition, in a case that a speech communication end signal from the mobile communication network is received independent of the communication partner, the processor 24 ends the speech communication processing.

With reference to FIG. 2, the camera module 36 is called an imager, and includes a focus lens 50, an image sensor 52, a CDS/AGC/AD circuit 54, a raw image data processing circuit 56, a Y/C data processing circuit 58, an AE evaluation circuit 60, a gain controlling circuit 62, an exposure time controlling circuit 64, a TG 66, an AF evaluating circuit 68, an AF driver 70 and an AF motor 72.

An optical image of an object is irradiated onto an imaging surface of the image sensor 52 through the focus lens 50. On the imaging surface of the image sensor 52, charge-coupled devices corresponding to SXGA (1280×1024 pixels) are arranged. Furthermore, on the imaging surface, a raw image signal corresponding to the optical image of the object is generated by photoelectronic conversion.

For example, when an operation of executing a camera function is performed by the user, the processor 24 instructs the TG 66 to repetitively perform a pre-exposure and thinning-out reading via the exposure evaluating circuit 60 and the exposure time controlling circuit 64 in order to execute through image processing. The TG 66 applies a plurality of timing signals to the image sensor 52 and the CDS/AGC/AD circuit 54 in order to execute pre-exposure of the imaging surface of the image sensor 52 and thinning-out reading of the electric charges obtained through the pre-exposure. The raw image signal generated in the imaging surface is read in response to a vertical synchronization signal Vsync generated every 1/30 to 1/15 sec. in an order according to a raster scanning.

Furthermore, the CDS/AGC/AD circuit 54, which is in synchronism with the image sensor 52 by a timing signal, performs a series of processing, such as correlative double sampling, automatic gain adjustment and A/D conversion on the raw image signal output from the image sensor 52. Also, the CDS/AGC/AD circuit 54 outputs the raw image data on which such processing is performed to the raw image data processing circuit 56. The raw image data processing circuit 56 performs white balance adjustment, etc. on the raw image data and outputs the resultant signal to the Y/C data processing circuit 58 and the AE evaluation circuit 60.

The Y/C data processing circuit 58 performs processing such as color separation, YUV conversion, etc. on the input image data to thereby output image data in the YUV format to the processor 24. The processor 24 (temporarily) stores the image data in the YUV format in the RAM 34. The image data in the YUV format is converted into image data in the RGB format. Then, the processor 24 applies the image data in the RGB format to the display driver 28 to thereby output the image data in the RGB format to the display 30. Thus, a low-resolution through-image representing an object is displayed on the display 30.

On the other hand, the exposure evaluating circuit 60 is called an AE controller, and creates a luminance evaluated value indicating brightness of an object scene based on the input image data. Furthermore, the luminance evaluated value is an average value of the luminance values of an AE evaluation area set to the image captured by the image sensor 52.

The created luminance evaluated value can be read by the processor 24, and the processor 24 applies an execution instruction of the AE controlling processing to the exposure evaluating circuit 60. The exposure evaluating circuit 60 receiving the execution instruction of the AE controlling processing controls the gain controlling circuit 62 and the exposure time controlling circuit 64 such that the luminance evaluated value is equal to an AE target value stored in the register (not illustrated).

First, the exposure evaluating circuit 60 controls the exposure time controlling circuit 64 to thereby change a frame rate and make an adjustment to an adequate exposure time. For example, as the frame rate is increased, the exposure time is short, and thus, the luminance of the image is low. Furthermore, as the frame rate is decreased, the exposure time is long, and thus, the luminance of the image is high.

Also, the exposure evaluating circuit 60 controls the gain controlling circuit 62, which is called a gain controller, to thereby adjust a gain of the CDS/AGC/AD circuit 54 to an appropriate value. For example, when the gain becomes high, the raw image signal is amplified to thereby make the luminance of the image high. Alternatively, when the gain becomes low, the raw image signal is not amplified to thereby make the luminance of the image low.

For example, when the camera function is turned on, the AE controlling processing is continuously executed irrespective of the presence or absence of a light emission of the LED 40. At this time, if the luminance evaluated value is lower than the AE target value (it is dark), a control is made such that the exposure time is made longer to make the image bright. Furthermore, if the luminance evaluated value is higher than the AE target value (it is bright), a control is made such that the exposure time is shorter to make the image dark. Then, if the control is made as described above, processing of calculating the difference between the current exposure time and the exposure time of the AE target value and changing the exposure time so as to lessen the difference is repeated. Here, in the present embodiment, a technique of adding a predetermined ratio (1/2, for example) of the difference between the exposure times to the current exposure time in order to lessen the difference between the exposure times is utilized. It should be noted that the aforementioned technique is a widely known general technique, and thus, the detailed description is omitted.

Then, after the exposure evaluating circuit 60 adjusts the image to adequate brightness, it outputs the image data to the AF evaluating circuit 68. The AF evaluating circuit 68 outputs an AF evaluated value indicating focus measure of the object scene on the basis of the image data. The processor 24 applies an instruction of changing the lens position of the focus lens 50 to the AF driver 70 on the basis of the AF evaluated value. The AF driver 70 drives the AF motor 72 on the basis of the instruction applied from the processor 24 to thereby change the lens position of the focus lens 50.

For example, when the shutter key is operated by the user, the processor 24 applies an instruction to the AE evaluation circuit 60 to thereby adjust the image to adequate brightness, and then executes the AF controlling processing. When the AF controlling processing is executed, the processor 24 moves the focus lens 50 while recording the AF evaluated value every frame. Furthermore, the processor 24 searches a peak (maximum value) of the AF evaluated values by a so-called hill-climbing search, moves the focus lens 50 to a lens position where the AF evaluated value takes a peak, and then executes main photographing processing. This makes it possible to store the image data for which the object is into focus.

Furthermore, when the main photographing processing is executed, signal processing is performed on a raw image signal output from the image sensor 52, and resultant image data through the processing is temporarily stored in the RAM 34. In addition, recording processing is performed on the flash memory 32. Specifically, the processor 24 reads the image data from the RAM 34, brings meta-information in the Exif format into association with the read image data, and records them in the flash memory 32 as one file. Additionally, the processor 24 outputs a sound for notifying that the main photographing processing is being executed from a speaker not shown. Also, when a memory card is connected to the mobile phone apparatus 10, image data may be stored in the memory card.

Furthermore, when there is no light source in its surroundings, or it is very dark irrespective of the presence of a light source, in a case that the shutter key is operated to execute main imaging processing, the LED 40 emits light as a flash. At this time, the processor 24 determines that there is no light source in its surroundings or it is very dark irrespective of the presence of a light source if the illumination of the object, that is, the luminance evaluated value of the image data is less than a predetermined value. Here, in another embodiment, the LED 40 may emit light as a flash under a condition different from the aforementioned condition.

In addition, when imaging by using a flash, the user can set the LED 40 such that it emits light twice. Here, if the LED 40 is set to emit light twice, by using an exposure time in a light emission at a first time, an exposure time when imaging by using a light emission at a second time different in brightness is made can be predicted. That is, the processor 24 predicts an exposure time at a second light emission (light emission at a second time) on the basis of a luminance evaluated value at a first light emission (light emission at a first time). Then, imaging is performed by using the exposure time thus predicted.

In this embodiment here, in a case that the LED 40 is made to emit light as a flash, the AE controlling processing is suspended to change from an exposure time when the LED 40 does not emit light to an exposure time after the LED 40 emits light. Then, when the LED 40 emits light, the AE controlling processing is restarted from a starting point of the AE control processing corresponding to the predicted exposure time to which a change is made. At this time, the aforementioned predicted exposure time is shorter than the exposure time when the LED 40 does not emit light, and therefore, the number of processing times before the exposure convergence point is decreased to thereby make the processing time for the AE controlling processing short.

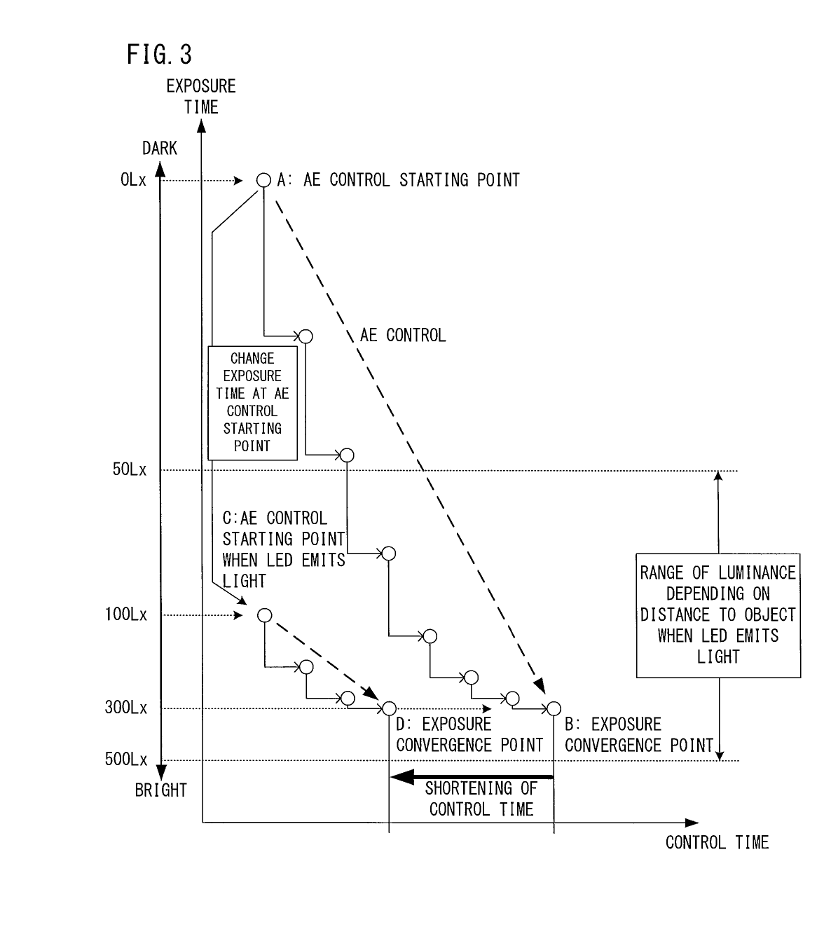

For example, FIG. 3 is a graph representing a relationship between a control time of the AE controlling processing and an exposure time. Furthermore, in this graph, the abscissa axis indicates a control time of the AE controlling processing (the number of controls), and the control time becomes long from left to right. Also, the ordinate indicates an exposure time and illumination of the object (Lx:lux) corresponding to the exposure time, and brightness increases from top to bottom in the drawing. Then, the exposure time corresponding to 50 Lx is “1/8.22 sec.”, the exposure time corresponding to 100 Lx is “1/11 sec.”, the exposure time corresponding to 300 Lx is “1/33 sec.”, and the exposure time corresponding to 500 Lx is “1/66 sec.” It should be noted that the illumination of the object has a correlation to a luminance of the image output by the image sensor 52, that is, the luminance evaluated value.

In a case that there is no light source in its surroundings, and the luminance is 0 Lx, the exposure time is a maximum time as to the image sensor 52. When the AE controlling processing is executed without changing the exposure time, the exposure time at a time when the LED 40 starts to emit light is indicated by an AE control starting point A (0 Lx), and the exposure time is shortened toward the exposure convergence point B (300 Lx) step by step for each frame.

On the contrary thereto, when the AE controlling processing is suspended before the LED 40 emits light to thereby change the exposure time to the predicted exposure time, the exposure time when the LED 40 starts to emit light is indicated by an AE control starting point C (100 Lx). Then, when the AE controlling processing is restarted, the exposure time is shortened toward the exposure convergence point D (300 Lx) step by step for each frame.

Then, as shown in FIG. 3, in a case that the exposure time is not changed, exposure compensation has to be performed seven times until arrival to the exposure convergence point B. However, in a case that the exposure time is changed to the predicted exposure time, it is only necessary to perform the exposure compensation three times until arrival to the exposure convergence point D. That is, the processing time when the AE controlling processing is performed by changing the exposure time to the predicted exposure time is made shorter than the processing time when the AE controlling processing is performed without changing the exposure time.

Here, the predicted exposure time is explained in detail. In this embodiment, by assuming the illumination of the object when the LED 40 emits light as a flash, the predicted exposure time is decided in advance. It should be noted that the illumination of the object changes depending on the distance from the LED 40 (mobile phone apparatus 10) to the object even if the LED 40 is bright on the same level. For example, if the distance to the object is short, it becomes bright, and if the distance to the object is long, it becomes dark inversely with the square of the distance.

Thus, if the object is so far from the LED 40, it is out of the reach of the flash of the LED 40, and therefore, this does not bring an effect of the light emission by the LED 40. Due to this, in view of the luminance when the LED 40 emits light as a flash and by using an imaging distance for general use (in the order of 50 cm to 100 cm, for example) as a guide, and further in view of the highest luminance state and the lowest luminance state within the range, the luminance capable of completing the AE controlling processing taking an approximately the same time in both states shall be an exposure control starting point (predicted exposure time).

In this embodiment, an effective range of luminance shall be 50 to 500 Lx, and the exposure time (1/11 sec.) corresponding to the 100 Lx shall be the predicted exposure time within the range. It should be noted that the predicted exposure time is influenced by the type of the LED 40 (characteristics), the specification of the LED control circuit 38, and the performance of the image sensor 52, and whereby, in another embodiment, the luminance corresponding to the predicted exposure time may be different.

By thus calculating the predicted exposure time in view of the type of the LED 40, the distance to the object, the performance of the image sensor 52, etc., the predicted exposure time can be set to a numerical value with high reliance.

It should be noted that in FIG. 3, the processing is performed so as to shorten the exposure time, but in a case that the LED 40 does not emit light as a flash, the exposure time may be compensated so as to be long.

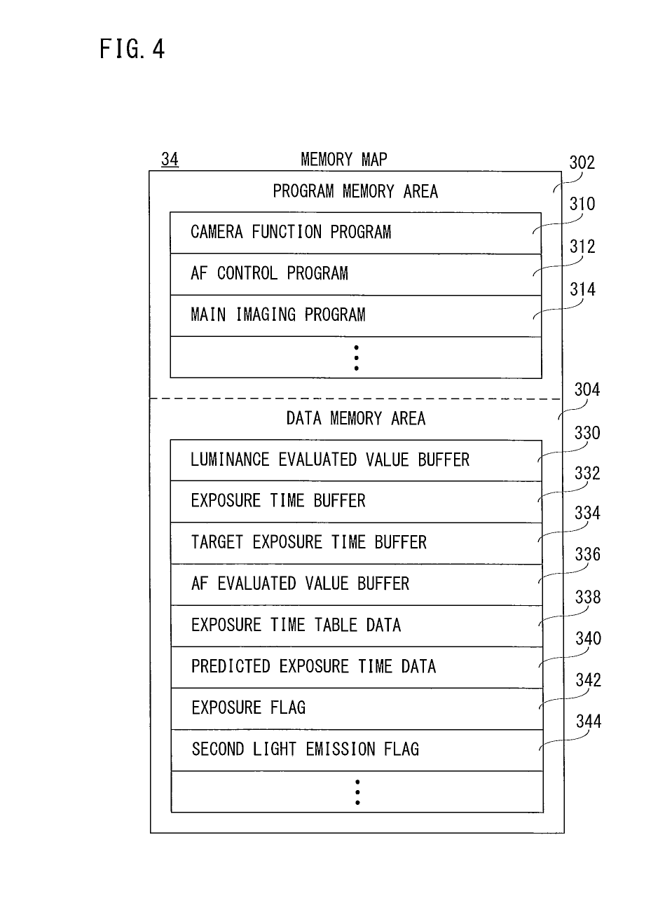

FIG. 4 is an illustrative view showing a memory map of the RAM 34. In the memory map of the RAM 34, a program memory area 302 and a data memory area 304 are included. A part of programs and data are read entirely at a time, or partially and sequentially as necessary from the flash memory 32, stored in the RAM 34, and then executed by the processor 24, etc.

In the program memory area 302, a program for operating the mobile phone apparatus 10 is stored. For example, the program for operating the mobile phone apparatus 10 is made up of a camera function program 310, an AF control program 312, a main imaging program 314, etc. The camera function program 310 is a program to be executed when the camera function is turned on. The AF control program 312 is a program for adjusting a focus with the focus lens 50. The main imaging program 314 is a program for storing the image captured by the image sensor 52 into the flash memory 32.

Although illustration is omitted, the program for operating the mobile phone apparatus 10 includes a program for notifying an incoming call state, a program for making communications with the outside, etc.

Succeedingly, in the data memory area 304, a luminance evaluated value buffer 330, an exposure time buffer 332, a target exposure time buffer 334, an AF evaluated value buffer 336, etc. are provided. Also, in data memory area 304, exposure time table data 338, predicted exposure time data 340, etc. are stored, and an exposure flag 342 and a second light emission flag 344 are provided.

In the luminance evaluated value buffer 330, a luminance evaluated value output from the exposure evaluating circuit 60 is temporarily stored. In the exposure time buffer 332, an exposure time decided based on the luminance evaluated value stored in the luminance evaluated value buffer 330 and the exposure time table data 338 is temporarily stored. In the target exposure time buffer 334, an exposure time corresponding to the AE target value is temporarily stored. In the AF evaluated value buffer 336, an AF evaluated value output from the AF evaluating circuit 68 is stored.

The exposure time table data 338 is a table in which the luminance evaluated value and the exposure time are associated with each other, and utilized when the current exposure time is evaluated as described above. The predicted exposure time data 340 is data indicating a predicted exposure time which is decided in advance, and is the exposure time corresponding to 100 Lx in this embodiment.

The exposure flag 342 is a flag for determining whether or not the AE controlling processing is completed, and is switched between ON and OFF on the basis of an output from the exposure evaluating circuit 60. For example, the exposure flag 342 is constituted of a one-bit register. When the exposure flag 342 is turned on (established), a data value “1” is set to the register. On the other hand, when the exposure flag 342 is turned off (not established), a data value “0” is set to the register.

Here, in another embodiment, it may be determined that the AE controlling processing is completed without using the exposure flag 342. For example, the processor 24 directly monitors the output from the exposure evaluating circuit 60, and may determine that the AE controlling processing is completed. In this case, the processor 24 determines that the AE controlling processing is completed when the output from the exposure evaluating circuit 60 changes from a LOW level to a HIGH level.

The second light emission flag 344 is a flag for determining whether or not a second light emission by the LED 40 is performed in a case that an imaging by using flash is executed. Also, the second light emission flag 344 is switched between ON and OFF depending on the setting by the user.

Although illustration is omitted, in the data memory area 304, data of images and character strings to be displayed on the display 30 are stored, and counters and flags necessary for operations of the mobile phone apparatus 10 are also provided.

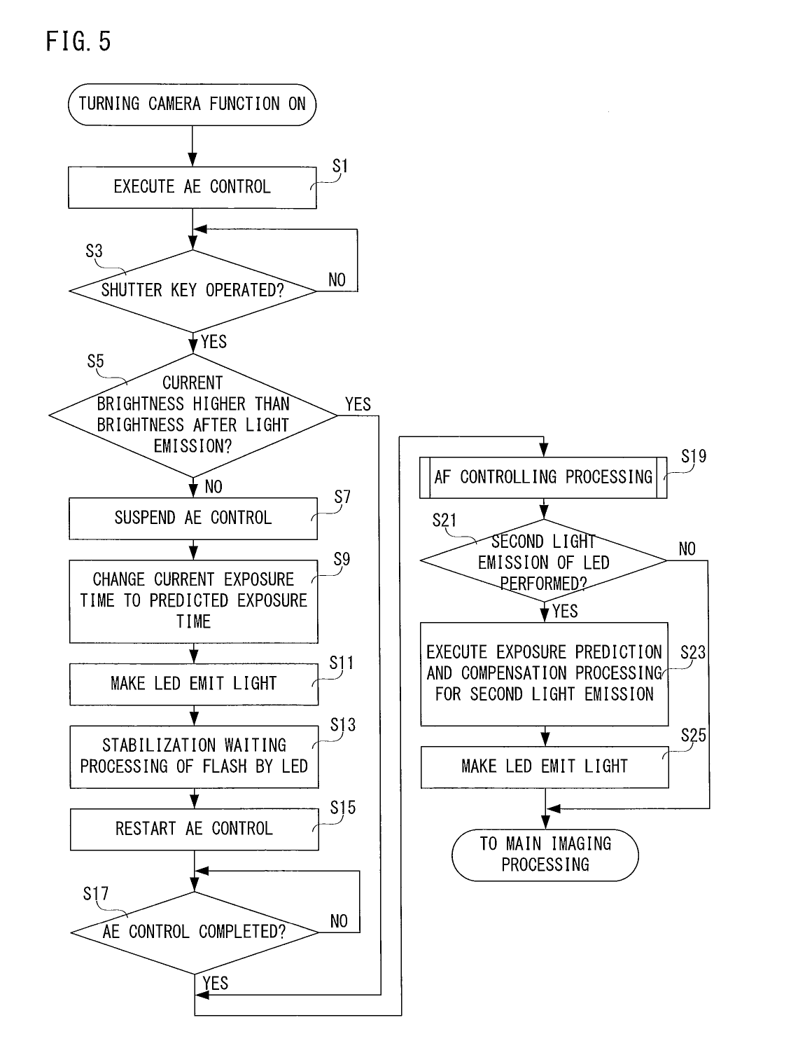

The processor 24 executes a plurality of tasks in parallel including camera function processing, etc. shown in FIG. 5 under the control of Linux (registered trademark)-based OSes, such as Android (registered trademark), REX, etc. and other OSes.

FIG. 5 is a flowchart showing the camera function processing. When a camera function is executed by the user, the processor 24 executes an AE control in a step S1. That is, an execution instruction of the AE controlling is applied to the exposure evaluating circuit 60. Furthermore, the luminance evaluated value output from the exposure evaluating circuit 60 is stored in the luminance evaluated value buffer 330, and the current exposure time based on the luminance evaluated value is stored in the exposure time buffer 332. In addition, a target exposure time corresponding to the AE target value is stored in the target exposure time buffer 334. Here, when the camera function is turned on, through-image displaying processing is executed at the same time as the camera function processing.

Succeedingly, in a step S3, it is determined whether or not the shutter key is operated. For example, it is determined whether or not the shutter key included in the key input device 26 is operated by the user. If “NO” in the step S3, that is, if the shutter key is not operated, the processing in the step S3 is executed again.

Alternatively, if “YES” in the step S3, that is, if the shutter key is operated, it is determined whether or not the current brightness is higher than the brightness after the LED 40 emits light in a step S5. That is, the processor 24 determines whether or not the luminance evaluated value of the image data is less than a predetermined value. Here, in the step S5 of another embodiment, it may be determined that the current exposure time is shorter than the exposure time corresponding to the lowest (dark) luminance within the effective illumination range. In this case, the processor 24 determines whether or not the current exposure time stored in the exposure time buffer 332 is shorter than the exposure time corresponding to 50 Lx shown in FIG. 3 in the step S5.

If “YES” in the step S5, that is, if the current brightness is higher than the brightness after the LED 40 emits light, an AF controlling processing is executed in a step S19 without performing the processing in steps S7 to S17. That is, if the current brightness is bright enough, the LED need not emit light, and therefore, by omitting the processing in the steps S7 to S17, the time relating to the imaging can be shortened.

Alternatively, if “NO” in the step S5, that is, if the current brightness is lower than the brightness after the LED 40 emits light, the AE control is suspended in the step S7. That is, the processor 24 applies a suspension instruction of the AE controlling processing to the exposure evaluating circuit 60 such that the predicted exposure time to which a change is made is not changed by the executing AE control. Succeedingly, in the step S9, the current exposure time is changed to the predicted exposure time. That is, the exposure time indicated by the predicted exposure time data 340 is stored in the exposure time buffer 332.

Then, in the step S11, the LED 40 is made to emit light. That is, the processor 24 makes the LED 40 emit light by controlling the LED control circuit 38. Succeedingly, in the step S13, flash stabilization waiting processing by the LED 40 is executed. That is, standby is hold until the luminance of the object scene changed by the flash reaches a value suitable for the AE control. Also, the stabilization of the flash is determined by a lapse of a predetermined time counted by the timer. Next, in the step S15, the AE control is executed again. That is, the processor 24 applies again an execution instruction of the AE controlling processing to the exposure evaluating circuit 60. Accordingly, the exposure time starts to change from the AE control starting point C toward the exposure convergence point D as shown in FIG. 3.

Succeedingly, in the step S17, it is determined whether or not the AE control is completed. That is, it is determined whether or not the end of the AE control is notified from the exposure evaluating circuit 60 based on the fact that the exposure time reaches the exposure convergence point D. More specifically, the processor 24 determines whether or not the exposure flag 342 is turned on. Here, in a case that the exposure flag 342 is not utilized, the processor 24 determines whether or not an output from the exposure evaluating circuit 60 changes from a LOW level to a HIGH level, for example.

If “NO” in the step S17, that is, if the AE control is not completed, the processing in the step S17 is repeatedly executed. Alternatively, if “YES” in the step S17, that is, if the AE control is completed, the AF controlling processing is executed in a step S19.

Succeedingly, it is determined whether or not the second light emission by the LED 40 is performed in a step S21. That is, it is determined whether or not the second light emission flag 344 is turned on.

If “NO” in the step S21, that is, if the second light emission is not set, for example, the process shifts to main imaging processing. If “NO” in the step S5, that is, if ambient brightness is high enough to eliminate the need of the light-emission as a flash, for example, “NO” is determined in the step S21 irrespective of the state of the second light emission flag 344. Here, depending on the ambient brightness, the second light emission may be performed. Furthermore, in a case that a forced light-emission mode of constantly emitting light is set as well irrespective of the ambient brightness, the second light emission is performed.

On the other hand, if “YES” in the step S21, that is, if the second light emission is set, exposure prediction and compensation processing for the second light emission is executed in a step S23. For example, on the basis of the luminance evaluated value in the first light-emission performed in the processing in the step S11, the exposure time in the second light-emission is predicted.

Succeedingly, in a step S25, the LED 40 is made to emit light. That is, the LED 40 is made to emit light again so as to make brighter than the first light-emission. Then, when the processing in the step S25 is executed, the main imaging processing is executed. That is, an image of the object scene on which light control is performed by the second light emission is imaged.

It should be noted that in a case that a setting of making the LED 40 constantly emit light in imaging is made, the processing in the step S5 is omitted. On the other hand, in a case that a setting of making the LED 40 not constantly emit light in imaging is set, the process shifts to the main imaging processing without executing the processing in the steps S3 to S17 and S21 to S25.

As understood from the above description, the mobile phone apparatus 10 is provided with the camera module 36 including the image sensor 52 and the exposure evaluating circuit 60. When the camera function is turned on, the image sensor 52 outputs image data, and the exposure evaluating circuit 60 executes the AE controlling processing on the basis of the exposure time corresponding to the luminance evaluated value of the image data. Furthermore, if the ambient is dark, and the illumination of the object is low, that is, in a case that the luminance evaluated value of the image data is less than the predetermined value, the LED 40 emits light as a flash in imaging. At this time, the AE controlling processing is suspended to change the current exposure time to the predicted exposure time. Then, the AE controlling processing is performed regarding the predicted exposure time after the change as a starting point of the control, and therefore, the processing time of the AE controlling processing is shortened.

Accordingly, the processing time of the AE controlling processing is shortened to thereby make the time relating to imaging short. Thus, usability in imaging by using the flash is improved.

Furthermore, the processing time of the AE controlling processing is shortened to thereby make the light-emission time of the LED 40 short, resulting in low power consumption during imaging.

Additionally, the predicted exposure time is a value decided irrespective of the current luminance value, etc., thus, prediction processing need not be performed in the AE control. This makes it possible to make the AE controlling processing simple.

Moreover, as in the present embodiment, a special component need not be added in order to perform the AE controlling processing, and therefore, it is possible to carry out the above-described invention without increasing the cost of the mobile phone apparatus 10.

It should be noted that the current exposure time may be calculated by means of not the exposure time table but by means of a transformation equation, etc.

In another embodiment, for search of a peak in the AF controlling processing, a full search may be adopted without being restricted to the hill-climbing search.

In a still another embodiment, brightness when the LED 40 emits light as a flash is changed, and the predicted exposure time may be changed in correspondence with the change of the brightness of the LED 40. For example, as processing to be executed in imaging, processing of estimating the illumination of the object from the luminance evaluated value, and changing the brightness when the LED 40 is made to emit light on the basis of the illumination of the object is conceivable. Furthermore, the brightness of the LED 40 has a correlation to the current value that flows in the LED 40, and therefore, the processor 24 can control the brightness of the LED 40 by controlling the current that flows in the LED 40. Thus, if a predicted exposure time table in which a plurality of current values and a plurality of predicted exposure times are bright into correspondence with each other is created in advance, the processor 24 can also change the predicted exposure time in correspondence with the brightness of the LED 40. That is, the processor 24 reads the appropriate predicted exposure time from the predicted exposure time table on the basis of the current value that flows in the LED 40 when the LED 40 emits light as a flash. In a further another embodiment, the predicted exposure time may be evaluated by inputting the current value in a formula (function).

Thus, in another embodiment, an adequate predicted exposure time can be decided on the basis of the illumination of the object, and therefore, it is possible to make the processing time of the AE controlling processing still shorter.

Furthermore, the communication system of the mobile phone apparatus 10 is the CDMA system, but an LTE (Long Term Evolution) system, a W-CDMA system, a GSM system, a TDMA system, an FDMA system and a PHS system may be adopted.

Moreover, the camera function program 310 used in the present embodiment may be stored in an HDD of a server for data delivery, and delivered to the mobile phone apparatus 10 via a network. Also, the camera function program 310 is stored in a recording medium like an optical disk, such as CD, DVD, BD (Blue-ray Disc), etc., a USB memory, a memory card, or the like, and the recording medium with it stored may be sold or distributed. Then, in a case that the camera function program 310 downloaded from the aforementioned server and recording medium is installed onto a mobile phone apparatus having a similar configuration to the present embodiment, an effect similar to the present embodiment can be obtained.

In addition, the present embodiment may be applied to smart phones and PDAs (Personal Digital Assistant) without being restricted to only mobile phone apparatuses 10.

It should be noted that all the concrete numerical values of the number of pixels, luminance value (Lx), the exposure time, the predicted exposure time, the number of processing and the distance that are depicted in the specification are all simple examples, and are changeable as necessary depending on the specification of the product.

The first embodiment is a camera device having an image sensor for outputting image data and an AE controller for performing an AE control based on an exposure time in correspondence with a luminance value of the image data output from the image sensor, comprising: a light-emitter which emits light when the luminance value is less than a predetermined value; and a storager which stores a predicted exposure time indicating a predetermined exposure time; wherein the AE controller performs an AE control based on the predicted exposure time in a case that the light-emitter emits light.

In the first embodiment, an image sensor (52) provided to a camera device (10: reference numeral illustrating a corresponding part in this embodiment. This holds true hereunder.) captures an object image, and outputs image data corresponding to the image. An AE controller (60) performs an AE control based on an exposure time decided in correspondence with a luminance value of the output image data. A light-emitter (40) emits light in a case that the ambient is dark, and thus the luminance value of the image data from the image sensor is less than the predetermined value. A storager (34) stores a predicted exposure time indicating a predetermined exposure time (1/11 sec.). In a case that the light-emitter emits light with the aforementioned conditions satisfied, the current exposure time is changed into the predicted exposure time, and the AE control is performed on the basis of the predicted exposure time.

According to the first embodiment, the AE control is performed on the basis of the predicted exposure time to thereby shorten the processing time of the AE control, capable of improving usability in imaging.

A second embodiment is according to the first embodiment, further comprising: a detector which detects illumination of the object, wherein the light-emitter changes brightness of the emitting light based on the illumination detected by the detector, and the predicted exposure time is decided on the basis of the brightness when the light-emitter emits light.

In the second embodiment, the detector detects illumination of the object on the basis of the luminance of the image. The brightness of the light by the light-emitter changes based on the detected illumination, and the predicted exposure time is decided on the basis of the brightness when the light-emitter emits light.

A third embodiment is according to the second embodiment, further comprising: a table in which each brightness when the light-emitter emits light and each of the predicted exposure times are brought into correspondence with each other, wherein the predicted exposure time is decided on the basis of the brightness when the light-emitter emits light and the table.

In the third embodiment, the brightness when the light-emitter emits light has a correlation to a current value that flows in the light-emitter. Therefore, in the table, each of current values of the current that flows in the light-emitter and each of the predicted exposure times are brought into correspondence with each other. Furthermore, the luminance of the image output from the image sensor has a correlation to the illumination of the object. In a case that the light-emitter emits light, the current value of the current that flows in the light-emitter is decided on the basis of the illumination of the object, and the predicted exposure time that is brought into correspondence with the current value is read from the table.

According to the second and third embodiments, on the basis of the illumination of the object, an adequate predicted exposure time is decided, capable of shortening the processing time of the AE control.

A fourth embodiment is according to the first embodiment, wherein the predicted exposure time is calculated by using a distance from the object.

According to the fourth embodiment, the predicted exposure time is calculated by means of the distance to the object, whereby, it is possible to set the predicted exposure time to a numerical value with a high reliance.

A fifth embodiment is according to the first embodiment, wherein the AE controller does not perform an AE control based on the predicted exposure time in a case that the luminance value is equal to or more than the predetermined value before the light-emitter emits light.

According to the fifth embodiment, if the current brightness is bright enough, the LED is not required to emit light, and therefore, by omitting the AE control based on the predicted exposure time, it is possible to make the time relating to the imaging shorter.

A sixth embodiment is according to the first embodiment, wherein the light-emitter includes an LED, and the predicted exposure time is decided on the basis of performance of the image sensor and a type of the LED.

According to the sixth embodiment, the predicted exposure time is calculated in view of the performance of the image sensor and the type of the LED, whereby, it is possible to set the predicted exposure time to a numerical value with high reliance.

A seventh embodiment is a mobile terminal having a camera device according to any one of embodiments 1 to 6.

According to the seventh embodiment, similar to the first embodiment, the AE control is performed on the basis of the predicted exposure time to thereby shorten the processing time of the AE control, capable of improving usability in imaging.

An eighth embodiment is an AE controlling method having an image sensor for outputting image data, an AE controller for performing an AE control based on an exposure time in correspondence with a luminance value of the image data output from the image sensor, a light-emitter which emits light when the luminance value is less than a predetermined value, and a storager which stores a predicted exposure time indicating a predetermined exposure time, comprising: detecting illumination of the object; changing brightness of the emitting light on the basis of the illumination detected by the detector; deciding a predicted exposure time on the basis of the brightness when the light-emitter emits light, and causing the AE controller to perform an AE control based on the predicted exposure time in a case that the light-emitter emits light.

In the eighth embodiment as well, similar to the second and third embodiments, an adequate predicted exposure time is decided on the basis of the illumination of the object, and therefore, it is possible to make the processing time of the AE control still shorter.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A camera device having an image sensor for outputting image data and an AE controller for performing an AE control based on an exposure time in correspondence with a luminance value of the image data output from said image sensor, comprising:
a light-emitter which emits light when said luminance value is less than a predetermined value; and
a storager which stores a predicted exposure time indicating a predetermined exposure time; wherein
said AE controller performs an AE control based on said predicted exposure time in a case that said light-emitter emits light.

2. A camera device according to claim 1, further comprising:
a detector which detects illumination of the object, wherein
said light-emitter changes brightness of the emitting light based on the illumination detected by said detector, and said predicted exposure time is decided on the basis of the brightness when said light-emitter emits light.

3. A camera device according to claim 2, further comprising:
a table in which each brightness when said light-emitter emits light and each of said predicted exposure times are brought into correspondence with each other, wherein
said predicted exposure time is decided on the basis of the brightness when said light-emitter emits light and said table.

4. A camera device according to claim 1, wherein
said predicted exposure time is calculated by using a distance from the object.

5. A camera device according to claim 1, wherein
said AE controller does not perform an AE control based on said predicted exposure time in a case that said luminance value is equal to or more than said predetermined value before said light-emitter emits light.

6. A camera device according to claim 1, wherein
said light-emitter includes an LED, and
said predicted exposure time is decided on the basis of performance of said image sensor and a type of said LED.

7. A mobile terminal having a camera device according to claim 1.

8. An AE controlling method having an image sensor for outputting image data and an AE controller for performing an AE control based on an exposure time in correspondence with a luminance value of the image data output from said image sensor, a light-emitter which emits light when said luminance value is less than a predetermined value, and a storager which stores a predicted exposure time indicating a predetermined exposure time, comprising:
detecting illumination of the object;
changing brightness of the emitting light on the basis of the illumination;
deciding a predicted exposure time on the basis of the brightness when said light-emitter emits light, and
causing said AE controller to perform an AE control based on said predicted exposure time in a case that said light-emitter emits light.
